(19) United States
(12) Patent Application Publication
(10) Pub. No.: US 2002/0172183 A1
(43) Pub. Date: Nov. 21, 2002

(54) Method and device for transmitting data in radio channels with strong multipath propagation and increased data volume in a radio communication system

(76) Inventors: Josef Eichinger, Neufinsing (DE); Wolfgang Zirwas, Grobenzell (DE); Marthias Lott, Munchen (DE)

Correspondence Address: STAAS & HALSEY LLP, 700 11TH STREET, NW, SUITE 500, WASHINGTON, DC, 20001, US

(21) Appl. No.: 10/147,352

(22) Filed: May 17, 2002

(30) Foreign Application Priority Data
May 17, 2001 (DE) 101 24 187.9
May 17, 2001 (EP) 011 121 35.7

(51) Int. Cl. H04J 1/00

(52) U.S. Cl. 370/343

(57) ABSTRACT

A data stream transmitted via a radio interface between two stations of a communication system includes user data blocks inserted in the data stream after supplementary data blocks relating to the data stream. To be able to transmit data with an increased response period or increased data volume, in each case at least two supplementary data blocks are inserted successively into the data stream and then the associated user data blocks are successively inserted.

### CROSS REFERENCE TO RELATED APPLICATIONS

This application is based on and hereby claims priority to German Application No. 101 24 187.9 filed May 17, 2001 and European Application No. 011 121 35.7 filed on May 17, 2001, the contents of which are hereby incorporated by reference.

### BACKGROUND OF THE INVENTION

In radio communication systems such as, for example, GSM (Global System for Mobile Communications), UMTS (Universal Mobile Telecommunications System) or HyperLAN or H2, as a local area data network, information, for example voice, image information or other data, are transmitted with the aid of electromagnetic waves via a radio interface between the transmitting station and the receiving station. The stations communicating via the radio interface are in most cases, on the one hand, a mobile subscriber station or a mobile computer respectively and, on the other hand, a stationary station at the network end. The station at the network end forwards data to and from other network facilities, the facilities at the network end being configured in accordance with the communication system.

In the current technology for wireless local area networks (WLAN: Wireless Local Area Network), H2 (HyperLAN Type 2), a first set of standards currently exists, the focus for applications in H2 being seen within buildings or offices with very little mobility or portability of the stations at the subscriber end. For this reason, five-channel models are specified with a maximum impulse response of less than 1 μs. H2 is based on an orthogonal frequency division multiplex (OFDM) method, using a guard interval before the actual data interval when dividing user data into a data transmission block, to prevent intersymbol interference (ISI) between adjacent OFDM symbols. The length of such a guard interval should be at least as long as the longest multipath component of the radio channel. In H2, a guard interval of 800 ns was specified, which is sufficient for typical office scenarios.

As can be seen from FIG. 1, a data sequence or data stream wherein supplementary data or guard intervals G1, G2 alternate in each case with user data D1, D2 is provided in the current H2 standard. The length of the supplementary data G1, G2 is presently in each case 800 ns and the length of the user data D1, D2 is in each case 3200 ns.

In the meantime, a number of new applications for public or partially public uses of H2 are being discussed. Some of these applications, however, also require mobile H2 terminals with high mobility, for example for exchanging data between vehicles or for vehicles which are passing traffic lights. For example, measuring campaigns are planned in order to determine the length of the impulse responses in such situations and it can already be expected that there will be impulse responses with a duration of longer than 800 ns, i.e. of the order of magnitude of 2 μs. Without countermeasures, H2 would fail due to the short guard interval of only 800 ns.

From terrestrial digital video broadcasting (DVB-T) it is known to increase the number of subcarriers (SCs) so that the length of the OFDM symbols can be increased. In the case of H2, such a procedure would require very extensive changes at the physical level and increase the hardware expenditure for the signal processing.

### SUMMARY OF THE INVENTION

It is an object of the invention to render H2 or comparable communication systems in mobile and public environments capable of also being used with relatively large data volumes in a data transmission block or in the case of an increased response period. In the case of H2, for example, long impulse responses of the order of magnitude of 1.6-2 μs should become possible. At the same time, the changes at the physical level of H2 should be kept at a minimum.

This object may be achieved by a method for transmitting data via a radio interface between two stations of a communication system, wherein the data are transmitted in a data stream and user data blocks are inserted in the data stream after supplementary data blocks relating to the data stream, particularly guard intervals. It is advantageous to use in each case at least two supplementary data blocks as one block in the data stream before the associated user data blocks are used as a subsequent block. Such a procedure increases the area for the supplementary data, particularly the guard interval, on the one hand, and, on the other hand, the area for user data is also multiplied in accordance with the number of combined user data blocks.

Devices having corresponding control and memory facilities and equipped with suitable software make it possible to implement such a method in the mobile stations or the stations at the network end of a radio communication system.

A large number of communication systems in normal operation use a supplementary data block or guard interval followed by an associated user data block in direct sequence in a data stream (FIG. 1). To be able to use these normal operating conditions optionally in the familiar manner, the method designated above is advantageously activated in the case of special operating requirements wherein case a number of supplementary data blocks or guard intervals are combined as one block in the data stream and only after that are the associated user data inserted into the data stream in a subsequent data block. Examples of special operating requirements that could be specified are an excessively long response time, longer data sequences and the length of a usual user data block or higher requirements for transmission reliability.

In a large number of communication systems, a Fourier transform is in each case applied before data are transmitted to the corresponding data blocks. After the reception, an inverse Fourier transform is correspondingly applied, which is sometimes also simply called decoding.

According to a particularly preferred embodiment wherein a number of data blocks having the same data content or the same data sequence are transmitted, a further Fourier transform is advantageously applied in the inverse transformation to an overlapping area of these data blocks. The area of overlap is suitably selected in such a manner that data which are not acquired in the first data block of two data blocks are correspondingly acquired in the second data block. This makes it possible, for example, to avoid disturbed low-frequency areas in the first data block or disturbed high-frequency areas in the second data block. It is particularly preferred in this connection to use one half of the third Fourier transform over the first data block and one half over the second data block in the case of adjacent user data blocks.

To minimize errors, the results of the various Fourier transforms which have been applied to data blocks of the same content are added and optionally divided by the number of results of Fourier transforms. In this process, use is made of the fact that a statistically different disturbance characteristic is superimposed in each of the transmitted data blocks. From the mathematical point of view, the addition of the results of the Fourier transforms corresponds to an averaging of the corresponding disturbing influences.

It is particularly in systems wherein the normal or conventional operation is used alternatingly with an operation proposed here for special operating requirements that it is of importance for the receiving station to find out the arrangement according to which the received data are to be processed. This can be done by appropriate signaling by the transmitting station.

In addition or as an alternative, the use of a method is also advantageous, in particular, wherein the data stream is examined at the receiver end for a sequence of two or more supplementary data blocks or, respectively, two or more directly following guard intervals as a sequence preceding a corresponding sequence of user data blocks. When such a situation is detected, corresponding processing can be initiated.

Instead of examining the data stream for corresponding sequences of supplementary data blocks, it is also possible, for example, to look for corresponding sequences of user data blocks.

This method can be advantageously used, in particular, if the transmitting station is not transmitting corresponding signaling since, as a result, it is also possible to handle situations wherein the transmitting station only forwards a corresponding special data sequence which it has received in this form from another facility.

Such a method can be used, in particular, in combination with the extension of the guard interval and this would lead to a reduced system capacity. In particular, such an extension is presently advantageously optionally possible by combining a number of guard intervals or supplementary data in one block. Compared with the fixed extension of the guard interval in, for example, the H2 standard, it is possible advantageously to dispense with a corresponding adaptation of the standard or, respectively, such an adaptation can be implemented with little expenditure and it is possible to avoid situations wherein an OFDM symbol composed of guard interval and user data part is only four μs, wherein case the 800 ns guard interval would constitute an overload of 25%.

Furthermore, the method described above can also be used in connection with systems wherein more or less intersymbol interference (ISI) between successive OFDM symbols is permitted and an equalizer removes this intersymbol interference in the base band. A combination with such a method, however, would result in giving up the greatest advantage of OFDM since this would be associated with high expenditure of signal processing in the base station modem.

In the text which follows, an exemplary embodiment will be explained in greater detail with reference to the drawing, wherein:

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a data sequence according to the prior art, for transmitting data in a radio communication system;

FIG. 2 is a block diagram of a conventional radio communication system;

FIG. 3 is a conventional data stream having a first data block to which a first Fourier transform is applied and a second data block to which a second Fourier transform is applied; and

FIG. 4 are data streams according to the present invention showing three different application areas of individual Fourier transforms.

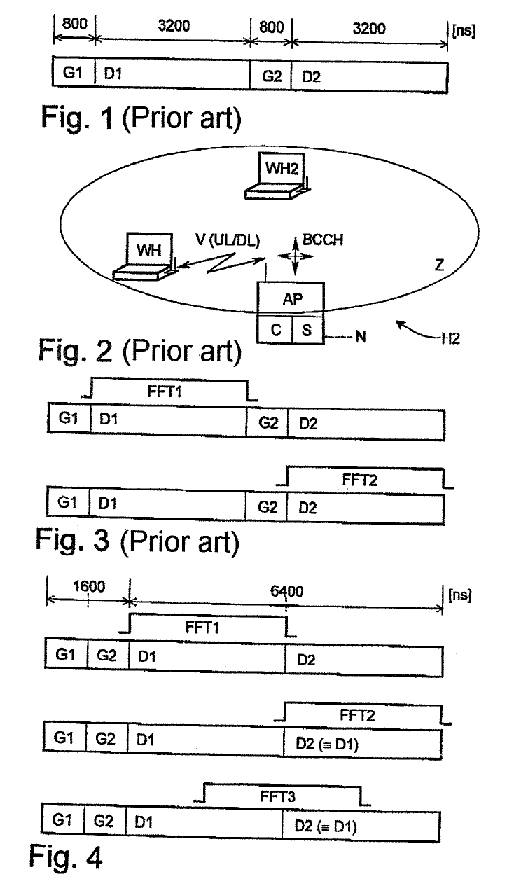

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

In an exemplary communication system, in this case an H2 radio communication system as the wireless local area data network as drawn in FIG. 2, a multiplicity of the most varied types of facilities are communicating with one another. In such a data network, the stationary access station is an access point AP which has a controller C, a storage facility S and other facilities and modules, with corresponding software functions, which are required for the operation. In a data network, some of these facilities, modules and software functions can also be moved out to other facilities, wherein case there is then a connection to other network facilities N.

The access point AP sets up a radio cell Z, and in particular if sectorized antennas are used, a number of radio cells Z can also be set up. Within this radio cell Z, stationary or mobile stations WH, WH2 at the subscriber end can communicate with the access point AP. On the one hand, the access point sends information via broadcast channels (BCCH) to the stations WH, WH2, e.g. mobile radio terminals located in its radio cell Z. On the other hand, direct connections V can be set up between the access point AP and in each case a single one of the stations WH. Via these connections V which form a direct radio interface, data are exchanged in the uplink direction UL and downlink direction DL. In the case of H2, the carrier frequency of the radio interface V is 5-6 GHz.

As can be seen from FIG. 3, the data are in each case inserted into a data stream at the transmitter end, and in the case of H2, in each case a guard interval G1 and a user data interval D1 are inserted directly one behind the other into the data stream before a further guard interval G2 with a further user data block D2 is inserted into the data stream. Before the user data D1, D2 are inserted into the data stream, a Fourier transform (FFT) is in each case applied to the user data. Arranged in the data stream, the data are then transmitted from the transmitting station, that is to say either the access point AP or the mobile station WH, via the radio interface V to the receiving station, that is to say conversely either the mobile station WH or the access point AP. In this receiving station WH and AP, respectively, the received data are then decoded or, respectively, processed in accordance with an inverse Fourier transform FFT1, FFT2 and are then handed over to corresponding facilities for further processing.

According to the preferred embodiment, the data are generally arranged, in the case of special operating requirements or optionally, in a data sequence in the data stream as shown in FIG. 4. Instead of arranging in each case a user data block G1, G2 or, in this case, a guard interval in direct alternation with the associated user data block D1 or D2, respectively, in the data stream, two or more supplementary data blocks G1 and G2, depending on requirement, are arranged in a direct sequence in the data stream before the associated user data or user data blocks are arranged in the data stream. In the case of H2, this would correspond to a doubling, tripling etc. of the guard interval and a doubling, tripling etc. of the subsequent user data block. In the example shown in FIG. 4, the guard interval would have a duration of 1600 ns instead of 800 ns and the user data block would have a duration of 6400 ns instead of 3200 ns.

According to a further aspect with its own inventive significance, the user data part can be transmitted twice or many times in order to minimize, for example, losses of capacity or disturbing components. In the present exemplary embodiment, this would correspond to the case wherein the data of the user data block D1 correspond to the data of the user data block D2. The data are processed with an OFDM symbol with in each case the same modulation applied to the latter, and inserted into the data stream. Naturally, such a method can also be used in the case of unmodulated data if in each case the same data are directly entered into the two user data blocks or data blocks before the Fourier transform is in each case applied to the corresponding data blocks.

Without additional measures, the loss of capacity is even greater than if only a user data part D1 were to be transmitted since the second user data part D2 does not carry any additional information. However, the second user data block D2 can be considered to be a repeated code, that is to say a certain redundancy has been added. If a first Fourier transform FFT1 is applied to the first user data block D1 before it is inserted in the data stream or before it is transmitted and correspondingly a second Fourier transform FFT2 is correspondingly applied to the second user data block D2, the same data are transmitted twice and at the receiver end an addition can be carried out. This addition of the received data at the receiver end corresponds to an increase in gain of the signal energy of e.g. 6 dB. Since the additive white Gaussian noise (AWGN) is uncorrelated for both data parts or user data blocks D1 and D2, noise picked up during the transmission acts as if it were geometrically added, as a result of which the noise increases by 3 dB after the two Fourier-transformed user data blocks FFT1 and FFT2 have been added. In the case of the exemplary repeated code, the effective total gain obtained is therefore, with a view to the signal/noise ratio S/N, S/N=(6−3)dB=3 dB.

A further improvement in the signal/noise ratio is possible if a third Fourier transform FFT3 is performed and is displaced with regard to the starting point of the Fourier transform in such a manner that it begins in the first data block D1 and ends in the second data block D2.

The starting point is advantageously selected in such a manner that it begins in the center of the first user data block D1 and ends in the center of the second user data block D2. In this case, the Fourier transform at the same time also shifts by half a symbol period of the OFDM symbol with respect to the duration. Whereas the signals are added constructively during an addition, the noise will be reduced again due to a lack of correlation according to the theorem of the additive white Gaussian noise (AWGN).

Due to the shift in time of the starting point of the third Fourier transform FFT3, there is a phase shift of all subcarriers but this can be easily estimated or directly determined and correspondingly corrected if the beginning of the displacement is known. In the case of previously predetermined starting times for the individual Fourier transforms FFT1, FFT2 and FFT3, this correction is known in advance and does not need to be estimated.

The higher signal/noise ratio can be used for transmitting with a higher modulation format or with reduced transmission power. Another possibility would be the increase of the code rate of the originally transmitted data symbol of the user data block D1. This, too, is possible because the repetition of the code adds redundancy which can be used for forward error correction FEC.

A further improvement is possible if the proposed transmission arrangement is used only if the duration of the channel transfer function exceeds a particular barrier. Otherwise, the method conforming to the standard can be used wherein bursts with a supplementary data block or, respectively, a guard interval followed immediately by a user data block are inserted into the data stream. This possibility of adaptation minimizes the loss of total capacity.

Advantageously, transmission in various types of communication systems is possible. For example, H2 systems can be used in environments having very long multipath components, for example in mobile environments. In this connection, use can be made of the fact that the relatively large subcarrier spacing of about 300 kHz in H2 provides for a very large Doppler spread which enables the mobile terminals to travel at very high speeds.

The loss of capacity can be minimized due to a longer guard interval. In the case of an implementation in the current H2 standard, this is possible as an optional solution since the length of the proposed new physical burst corresponds exactly to twice or several times the length of the standardized physical H2 burst. Advantageously, a processing power which is increased only relatively slightly is required for a corresponding new operating mode in mobile applications.

If there are losses of capacity, they depend on the strategy selected and on possible implementation losses. For example, there is an increased loss of capacity if the extension of the supplementary data block or guard interval extends over more than two original supplementary data blocks.

When two Fourier transforms FFT1 and FFT2 are used, no additional processing power is needed in comparison with a standardized H2 receiver and with a predetermined time window. If a third Fourier transform FFT3 is used, however, additional processing power must be taken into consideration. The execution of the third Fourier transform FFT3 can be advantageously placed in the area of the subsequent extended supplementary data block in time so that optimum utilization of the system resources becomes possible. At the transmitter end, the required expenditures are even less than with a standardized H2 transmitter since the data of the second Fourier transform FFT2 are exactly the same as the data of the first Fourier transform FFT1 and, therefore, only need to be calculated once.

Since the data samples of the guard intervals and of the Fourier transforms FFT1, FFT2 are exactly the same due to the cyclic extension to the guard interval, it is possible to set the starting time for the first Fourier transform FFT1 freely by a known time displacement. This makes it possible to adapt the length of the guard interval to the length of the actual length of the channel impulse response. As a result of such a time displacement, the Fourier transforms FFT1 and FFT2 will partially overlap, but this only causes a slight deterioration since the user data are still complete and a non-optimum result is only registered in the averaging of the noise data. The phase rotation around the known time displacement of the subcarriers can be easily corrected.

Advantageously, the corresponding operating mode, that is to say standard mode or transmission of combined data blocks, is signaled from the transmitter to the receiver so that the receiver is informed about how the received data are to be processed. However, a method for detecting the processing required for the received data in the receiver is also possible additionally or as an alternative. For this purpose, in each case two successively received bursts or data blocks can be compared over a time of a supplementary data block G1 and of a user data block D1 at the receiver end. Taking into consideration slight data changes due to noise which has been added during the transmission via the air interface, it is also possible to automatically draw conclusions regarding the corresponding operating mode with extended data blocks in the case of identical data contents of two successive data blocks. Apart from examining received data for a sequence of user data blocks having the same user data content, an examination whether a supplementary data sequence or, respectively, an extended guard interval without data content has been received is also possible.

The invention has been described in detail with particular reference to preferred embodiments thereof and examples, but it will be understood that variations and modifications can be effected within the spirit and scope of the invention.

What is claimed is:

1. A method for transmitting data via an interface between two stations of a communication system, comprising:
transmitting a first data stream with user data blocks successively inserted behind at least two successively inserted supplementary data blocks relating to the data stream.

2. The method as claimed in claim 1,
further comprising a normal operating mode in which one supplementary data block providing a guard interval precedes each user data block in a second data stream, and
wherein said transmitting of the first data stream is used for special operating requirements.

3. The method as claimed in claim 2, further comprising signaling a transmission sequence used from a transmitting station to the receiving station.

4. The method as claimed in claim 2, wherein the special operating requirements include at least one of a long response time, a data sequence having a length greater than a single user data block and higher transmission reliability.

5. The method as claimed in claim 2, further comprising:
examining a received data stream at a receiving station for the special operating requirements indicated by at least one of a sequence of at least two supplementary data blocks before a sequence of user data blocks and successive user data blocks having identical user data content; and
initiating special operating processing upon detection of the special operating requirements.

6. The method as claimed in claim 5, further comprising applying at least one Fourier transform to the user data blocks received at the receiver station.

7. The method as claimed in claim 6, wherein said applying of at least one Fourier transform is performed using a Fourier transform on adjacent first and second data blocks each having an identical data sequence, parts of the first data block and parts of the second data block being included in the Fourier transform.

8. The method as claimed in claim 7, wherein one half of the Fourier transform is applied over a second half of the first data block and one half is applied over a first half of the second data block.

9. The method as claimed in claim 6,
wherein a number of Fourier transforms are applied over a sequence of the user data blocks each having an identical data sequence, and
wherein said method further comprises adding results of the Fourier transforms for error minimization

10. The method as claimed in claim 9, further comprising dividing the results of the Fourier transforms by the number of the Fourier transforms.

11. The method as claimed in claim 9, wherein the Fourier transforms are in each case only applied to a length of one user data block.

12. A device in a communication system having at least two stations transmitting data therebetween, comprising:
a storage facility to store data in a first data stream; and
a controller to successively insert user data blocks into the first data stream behind successively inserted supplementary data blocks relating to the data stream.

13. The device as claimed in claim 12, wherein said storage facility temporarily stores received user data blocks for later processing by said controller with subsequently received user data blocks.

14. The device as claimed in claim 12, wherein said controller transmits the first data stream for special operating requirements and further forms a second data stream in a normal operating mode in which one supplementary data block providing a guard interval precedes each user data block.

15. The device as claimed in claim 12, wherein said controller further examines a received data stream for the special operating requirements indicated by at least one of a sequence of at least two supplementary data blocks before a sequence of user data blocks and successive user data blocks having identical user data content and initiates special operating processing upon detection of the special operating requirements.

16. The device as claimed in claim 15, wherein said controller further applies at least one Fourier transform to the user data blocks in the received data stream.

17. The device as claimed in claim 15, wherein said controller further applies at least a Fourier transform on adjacent first and second data blocks each having an identical data sequence, parts of the first data block and parts of the second data block being included in the Fourier transform.

18. The device as claimed in claim 17, wherein said controller applies one half of the Fourier transform over a second half of the first data block and one half over a first half of the second data block.

19. The device as claimed in claim 16, wherein said controller applies a number of Fourier transforms over a sequence of the user data blocks each having an identical data sequence and adds results of the Fourier transforms for error minimization

20. The device as claimed in claim 19, wherein said controller divides the results of the Fourier transforms by the number of the Fourier transforms.
